(19) United States
(12) Patent Application Publication
(10) Pub. No.: US 2026/0357895 A1
(43) Pub. Date: Nov. 12, 2026

(54) METHODS FOR CONTROLLING A HYDRAULIC ASSEMBLY

(71) Applicant: Schaeffler Technologies AG & Co. KG, Herzogenaurach (DE)

(72) Inventors: Carsten Mayer, Lohr a. Main (DE); Yunfan Wei, Bühl (DE)

(73) Assignee: Schaeffler Technologies AG & Co. KG, Herzogenaurach (DE)

(21) Appl. No.: 19/137,643

(22) PCT Filed: Nov. 30, 2023
(86) PCT No.: PCT/DE2023/100932

§ 371 Date: Jun. 11, 2025

(30) Foreign Application Priority Data
Dec. 15, 2022 (DE) 10 2022 133 400.7

(51) Int. Cl. F16H 63/34; F16D 48/02

(52) U.S. Cl. CPC F16H 63/3483; F16D 48/02; F16D 2048/0245

(57) ABSTRACT

A method for controlling a hydraulic assembly includes providing a hydraulic assembly with an electric motor, a pressure line filled with a hydraulic fluid, a pump, rotationally driven by the electric motor to provide a system pressure to the hydraulic fluid, a pressure control valve arranged for controlling the system pressure, and a functional component arranged to be operated by the hydraulic fluid. The method also includes calculating a pump volume flow of the hydraulic fluid through the pump, calculating a volume requirement in the pressure line, and calculating a volume flow through the pressure control valve using the pump volume flow and the volume requirement.

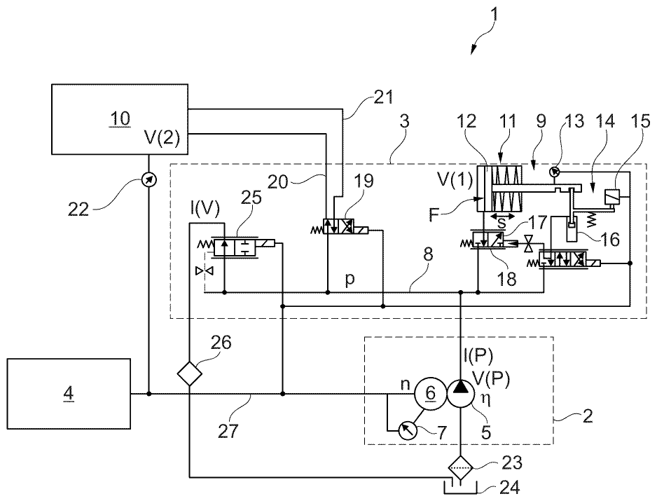

### CROSS-REFERENCE TO RELATED APPLICATIONS

This application is the United States National Phase of PCT Appln. No. PCT/DE2023/100932 filed Nov. 30, 2023, which claims priority to German Application No. DE102022133400.7 filed Dec. 15, 2022, the entire disclosures of which are incorporated by reference herein.

### TECHNICAL FIELD

The present disclosure relates to a method for controlling a hydraulic assembly having a pump which is rotationally driven by an electric motor and providing a system pressure of a pressure line filled with hydraulic fluid, a pressure control valve controlling the system pressure, and at least one pressure-actuated functional component integrated into the pressure line.

### BACKGROUND

A method for controlling an electric pump for a hydraulic system, such as a hydraulic assembly having a pump which is rotationally driven by an electric motor, is known from the publication WO 2022/012711 A1. The pump provides a system pressure for a separating clutch for separating two drive train parts of a drive train of a motor vehicle and a parking lock for the same. The functional components for actuating these are designed as slave cylinders. The system pressure is set by means of a pressure control valve.

A hydraulic system having a pump which is rotationally driven by an electric motor, which sets a system pressure in a hydraulic line and has a device integrated into the hydraulic line for detecting a volume flow, is known from the publication DE 10 2019 122 694 A1.

### SUMMARY

The present disclosure provides a method for controlling a hydraulic assembly. In particular, the present disclosure uses the method to determine a volume flow through the pressure control valve without providing further hydraulic components for detecting the volume flow and thus to design the hydraulic assembly simply and cost-effectively.

The proposed method is used to control a hydraulic assembly, in particular in a drive train of a motor vehicle for actuating a parking lock, a separating clutch for separating and connecting drive train parts, for example an internal combustion engine from an electric motor, a drive unit having an internal combustion engine and an electric motor from the rest of the drive train and/or the like. The hydraulic assembly can also be used to cool components of the drive train using hydraulic fluid.

A pump, for example a vane pump, axial or radial piston pump or, for example, a gear pump, is provided for generating a volume flow and the resulting system pressure in a pressure line. The pump is rotationally driven by an electric motor, for example a brushless commutated electric motor having a corresponding sensor system such as one or more Hall sensors for detecting and controlling the rotation variables, such as the rotational speed, angular speed, angle of rotation, rotational acceleration and/or the like of the rotor and thus the rotation variables of the pump. The system pressure is controlled by means of a pressure control valve depending on consumers, such as at least one pressure-actuated functional component, and the system pressure is set by opening and closing the pressure control valve accordingly by discharging a corresponding volume flow of the hydraulic valve into a pressureless sump.

The volume flow is estimated by the pressure control valve depending on a pump volume flow delivered by the pump and a volume requirement in the pressure line. The estimated volume flow can be used for improved control of the pressure control valve, as the flow forces arising from the volume flow can be estimated and compensated for by the pressure control valve, so that a flow-pressure characteristic of the pressure control valve that is dependent on the volume flow can be controlled in an improved manner.

The pump volume flow generated by the pump through appropriate control by means of a central control unit is continuously determined from at least one rotation variable of the electric motor, a displacement volume of the pump and its efficiency. The efficiency can be determined in a simple and approximate manner. The pressure at the pump can be assumed to be constant or its influence on the efficiency can be disregarded. The efficiency can thus be determined exclusively depending on the temperature of the pump or a variable determined for this purpose and a rotation variable of the electric motor, for example the rotational speed of the rotor of the electric motor. Corresponding characteristic curves, characteristic maps or mathematical equations of the efficiency reflecting the behavior can be stored in the central control unit depending on the rotation variable and the temperature and, if necessary, the pressure and, if necessary, read out and calculated to determine the efficiency and, if necessary, adapted to changing conditions of the hydraulic assembly.

The at least one rotation variable of the electric motor continuously recorded to determine the displacement volume can be, for example, a rotational speed, an angular speed, an angular acceleration and/or the like, for example of one or more Hall sensors, for example for commutating and controlling the electric motor. The rotational speed of the pump is determined from the rotation variables. The rotation variables for determining the rotational motion of the pump can also be determined without sensors, for example from measured electrical currents and/or commutation specifications for operating the electric motor. Any transmission ratio set between the rotor of the electric motor and a pump axis driven by the rotor is taken into account. Substantially constant slip, leakage and/or similar phenomena present at the pump, as determined by recorded parameters such as temperature, viscosity of the hydraulic fluid and/or similar, can be determined and taken into account when determining the displacement volume as part of the efficiency calculation or separately.

The volume requirement in the pressure line depends on the individual volume consumptions of one or a plurality of functional components and the nature of their function as well as any leaks within the pressure line with its at least one functional component. For example, the complete or partial volume requirement of the at least one functional component results from the absorption of hydraulic fluid during its actuation or resetting after its actuation. For example, at least one functional component can be designed as a slave cylinder, and their volume requirement results at least in part from a stroke such as an actuation path and a piston surface of a slave cylinder piston of the slave cylinder, so that its volume requirement can be determined from the determined effective volume of the actuation path of the slave cylinder and its piston surface. The actuation path of the slave cylinder, such as the stroke of the slave cylinder piston, can be determined, for example, by means of a path sensor for path-dependent control of the actuation of the slave cylinder and thus actuation of an associated actuation device in a drive train, for example a parking lock and/or a separating clutch by means of the control unit.

In addition to the volume requirement of the at least one functional component during its actuation, a variable that takes into account losses such as leakages and/or the like of the hydraulic fluid can also be taken into account to determine the volume flow of the pressure control valve. For example, such a variable can be estimated depending on the temperature, viscosity, age and/or other properties of the hydraulic fluid and/or the pressure line with its at least one functional component, taken into account as a constant or, if necessary, disregarded.

The total volume requirement can, for example, be formed as a sum parameter from the volume requirement of the at least one functional component and, if applicable, from the variable estimating a loss of hydraulic fluid. This sum parameter can be calculated at any time and subtracted from the pump volume flow. The result obtained then gives the estimated volume flow at the pressure control valve. The flow force influence on the pressure control valve can be compensated with this currently estimated volume flow.

### BRIEF DESCRIPTION OF THE DRAWINGS

The present disclosure is explained in more detail with reference to the exemplary embodiment in the single figure. This shows a hydraulic diagram of a possible hydraulic assembly 1 for carrying out the proposed method in a schematic representation.

### DETAILED DESCRIPTION

The hydraulic assembly 1 is divided into the pump unit 2, the hydraulic part 3, and the control unit 4. The pump unit 2 contains the pump 5, which is rotationally driven by the rotor of the electric motor 6. The rotation variables of the rotor are recorded using the sensor 7, for example one or a plurality of Hall sensors. The electric motor 6 can be controlled by the control unit 4 and a power electronics unit using the recorded rotation variables.

The pump 5 is designed as a gear pump, for example, and draws hydraulic fluid, for example hydraulic oil, from the unpressurized sump 24 with the filter unit 23 connected in between. The displacement volume V(P) of the pump 5 and its efficiency n, which depends, for example, on the temperature of the pump 5, the viscosity of the hydraulic fluid, its slip and its leakage, are known or are continuously determined. The pump volume flow I(P), which is discharged into the pressure line 8 of the hydraulic part 3, is continuously determined from a rotation variable of the sensor 7, for example the rotational speed n of the rotor and the displacement volume V(P).

The two hydraulically active functional components 9, 10 are integrated into the pressure line 8, which functional components require the volume requirements V(1) and V(2) to operate. The functional component 9 actuates a parking lock, for example, by means of the slave cylinder 11. The actuation path s of the slave cylinder piston 12 of the slave cylinder 11 during its actuation is detected by means of the path sensor 13. The volume requirement V(1) results from the product of the actuation path s and the piston surface F of the slave cylinder piston 12. The latching mechanism 14 holds the parking lock in its open and closed position respectively. For this purpose, the electric switching valve 15 is provided for activating and the hydraulic cylinder 16 switched by the valve 17 for deactivating the latching mechanism 14. The volume requirement of the cylinder 16 is taken into account if necessary. The slave cylinder 11 is actuated by switching the valve 18 as soon as the latching mechanism 14 is deactivated by means of the valve 17.

The functional component 10 is used, for example, to actuate a separating clutch and is only shown in block circuit form. These are actuated by switching the valve 19, which controls a slave cylinder by means of the hydraulic fluid guided in the lines 20, 21, the actuation path of which is detected by the path sensor 22, so that the volume requirement V(2) can be determined from the surface of the slave cylinder piston of this slave cylinder and the detected actuation path.

The system pressure p in the pressure line 8 is set by means of the pressure control valve 25, which is opened accordingly and connected to the sump 24 with the heat exchanger 26 connected in between to cool the hydraulic fluid flowing out.

The control unit 4 uses the simplified electrical connection 27 to control the electric motor 5, the valves 17, 18, 19, the electric switching valve 15 and the pressure control valve 25 and records the measurement signals from the sensor 7 and the path sensors 13, 22.

To estimate the volume flow I(V) flowing through the pressure control valve 25, the pump volume flow I(P) may be determined currently and continuously, taking into account the volume requirement of the pressure line 8, for example to estimate the flow force influences that prevail at the pressure control valve 25 and to compensate for them if necessary. The volume requirement of the pressure line has, as a good approximation, the volume requirement V(1) of the functional component 9, the volume requirement V(2) of the functional component 10 and, if necessary, a variable G assumed in the dimension of a volume, in which further volume requirement components, for example of a leakage in the pressure line 8, the volume requirement of the cylinder 16 and/or the like can be recorded. In the simplest case, the volume requirement of the pressure line 8 is subtracted from the pump volume flow I(P) according to the following equation with the variables listed above to estimate the volume flow I(V) in the control unit 4:

I(V)=I(P)−(V(1)+V(2)+G))

### REFERENCE NUMERALS

1 Hydraulic assembly
2 Pump unit
3 Hydraulic part
4 Control unit
5 Electric motor
6 Pump
7 Sensor
8 Pressure line
9 Functional component
10 Functional component
11 Slave cylinder
12 Slave cylinder piston
13 Path sensor
14 Latching mechanism
15 Switching valve
16 Cylinder
17 Valve
18 Valve
19 Valve
20 Line
21 Line
22 Path sensor
23 Filter unit
24 Sump
25 Pressure control valve
26 Heat exchanger
27 Connection
F Piston surface
I(P) Pump volume flow
I(V) Volume flow
n Rotational speed
p System pressure
S Actuation path
V(P) Displacement volume
V(1) Volume requirement
V(2) Volume requirement
η Efficiency

1. A method for controlling a hydraulic assembly having a pump which is rotationally driven by an electric motor and providing a system pressure of a pressure line filled with a hydraulic fluid, a pressure control valve controlling the system pressure, and at least one pressure-actuated functional component integrated into the pressure line, characterized in wherein a volume flow through the pressure control valve is estimated depending on a pump volume flow delivered by the pump and a volume requirement in the pressure line.

2. The method according to claim 1, wherein the pump volume flow is determined from at least one rotation variable of the electric motor, a displacement volume of the pump and its efficiency.

3. The method according to claim 2, wherein the rotation variable is a rotational speed or an angular speed of a rotor of the electric motor.

4. The method according to claim 2, wherein the pump volume flow is determined depending on a temperature of the hydraulic fluid.

5. The method according claim 1, wherein the at least one functional component is designed as a slave cylinder and the volume requirement is determined at least partially from an actuation path and a piston surface of a slave cylinder piston of the slave cylinder.

6. The method according to claim 5, wherein the actuation path of the slave cylinder piston is determined depending on a path sensor.

7. The method according to claim 5, wherein the at least one functional component arranged to actuate a parking lock or a separating clutch of drive train parts of a drive train of a motor vehicle.

8. The method according to claim 1, wherein the volume flow is additionally determined depending on a variable estimating a leakage of the hydraulic fluid.

9. The method according to claim 1, wherein the volume requirement of the at least one functional component and optionally of a variable estimating a leakage of the hydraulic fluid is formed as a sum parameter in real time and this sum parameter is subtracted from the pump volume flow to form a current volume flow at the pressure control valve.

10. The method according to claim 1, wherein a flow force influence on the pressure control valve is compensated by means of the volume flow through the same.

11. A method for controlling a hydraulic assembly, comprising:
providing the hydraulic assembly, the hydraulic assembly comprising:
an electric motor;
a pressure line filled with a hydraulic fluid;
a pump, rotationally driven by the electric motor to provide a system pressure to the hydraulic fluid;
a pressure control valve arranged for controlling the system pressure; and
a functional component arranged to be operated by the hydraulic fluid;
calculating a pump volume flow of the hydraulic fluid through the pump;
calculating a volume requirement in the pressure line; and
calculating a volume flow through the pressure control valve using the pump volume flow and the volume requirement.

12. The method of claim 11, wherein the pump volume flow is calculated using a rotation of the electric motor, a displacement volume of the pump, and an efficiency of the pump.

13. The method of claim 12, wherein:
the electric motor comprises a rotor; and
the rotation of the electric motor is a rotational speed or an angular speed of the rotor.

14. The method of claim 12, further comprising measuring a temperature of the hydraulic fluid, wherein the calculating the pump volume flow uses the temperature.

15. The method of claim 11, wherein:
the functional component is a slave cylinder comprising a slave cylinder piston;
the slave cylinder piston comprises an actuation path and a piston surface; and
the calculating the volume requirement in the pressure line uses the actuation path and the piston surface.

16. The method of claim 15 further comprising measuring the actuation path using a path sensor.

17. The method of claim 15, wherein the slave cylinder is arranged to:
actuate a parking lock of a motor vehicle; or
actuate a separating clutch of a motor vehicle.

18. The method of claim 11, wherein the calculating the volume flow uses an estimated leakage of the hydraulic fluid.

19. The method of claim 18, wherein the volume flow is calculated by subtracting the volume requirement and the estimated leakage from the pump volume flow.

20. The method of claim 11, wherein the volume flow is calculated using a flow force influence on the pressure control valve.
